(19) United States
(12) Patent Application Publication
(10) Pub. No.: US 2025/0252095 A1
(43) Pub. Date: Aug. 7, 2025

(54) ARTIFICIAL INTELLIGENCE-BASED QUERY GENERATION FOR CYBERSECURITY DATA SEARCH

(71) Applicant: Google LLC, Mountain View, CA (US)

(72) Inventors: Spencer Daniel Lichtenstein, Greenville, SC (US); Abubakar Wawda, Cupertino, CA (US); Shapor Naghibzadeh, San Francisco, CA (US)

(21) Appl. No.: 18/431,192

(22) Filed: Feb. 2, 2024

(51) Int. Cl. G06F 16/242

(52) U.S. Cl. CPC G06F 16/2428; G06F 16/243

(57) ABSTRACT

A method includes receiving a request to generate a formal language query to search cybersecurity data associated with a plurality of computing resources of one or more entities, wherein the request specifies a natural language query pertaining to the cybersecurity data. The method further includes generating a prompt comprising: (i) at least part of the natural language query (ii) a set of instructions for generating the formal language query and (iii) one or more examples pertaining to the natural language query. The method further includes providing the prompt as input to a trained generative artificial intelligence (AI) model. The method further includes obtaining one or more outputs of the trained generative AI model, the one or more outputs indicating a formal language query corresponding to the natural language query. The method further includes causing the formal language query to be executed to search the cybersecurity data.

### TECHNICAL FIELD

Aspects and implementations of the present disclosure relate to computer security, and in particular to artificial intelligence-based query generation to search cybersecurity data for malicious activity relating to computing resources.

### BACKGROUND

Computing resources, such as servers, data centers, and cloud computing platforms, can be susceptible to malicious activity (e.g., malware, network-based attacks). Malicious activity can lead to interruption or inefficient operation of computing devices, which can be problematic for owners and operators of computing devices. In extreme cases, malicious activity can damage computing devices or data stored thereon, potentially causing substantial financial loss and other losses and liabilities for the owners and operators of computing devices.

Typical measures to protect against malicious activity are often inadequate and have resulted in the proliferation of large numbers of disparate cybersecurity operations tools, such as Security Orchestration, Automation, and Response (SOAR) platforms, Security Information and Event Management (SIEM) systems, Intrusion Detection Systems (IDS), Intrusion Prevention Systems (IPS), antivirus software, endpoint protection, vulnerability management tools, and more. Each of these tools can generate large amounts of cybersecurity data, which can often be formatted according to diverse structures or formats that are not easily combined or reconciled with each other. Data analytics platforms typically review and act on malicious activity. However, reviewing and acting upon the staggering volume and diversity of data generated by such ever-increasing numbers of cybersecurity operations tools is complex and cumbersome, leading to inefficiencies and vulnerabilities.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

In some implementations, a method is disclosed for generating domain-specific queries to search cybersecurity data, wherein the method includes receiving a request to generate a formal language query to search cybersecurity data associated with a plurality of computing resources of one or more entities, wherein the request specifies a natural language query pertaining to the cybersecurity data associated with the plurality of computing resources. The method can further include generating a prompt comprising: (i) at least part of the natural language query (ii) a set of instructions for generating the formal language query and (iii) one or more examples pertaining to the natural language query. The method further includes providing the prompt as input to a trained generative artificial intelligence (AI) model. The method can further include obtaining one or more outputs of the trained generative AI model, the one or more outputs indicating a formal language query corresponding to the natural language query. The method can further include causing the formal language query to be executed to search the cybersecurity data associated with the plurality of computing resources.

In some embodiments, the method further includes providing a user interface (UI) comprising one or more UI elements for receiving the request to generate the formal language query, wherein the one or more UI elements is presented in a first area of the UI.

In some embodiments, the method further includes causing the formal language query to be presented in a second area of the UI.

In some embodiments, the UI comprises one or more additional UI elements for receiving the request to provide feedback on the query.

In some embodiments, the method further includes receiving a request to modify the formal language query, wherein the UI comprises one or more additional UI elements for receiving the request to modify the formal language query. In some embodiments, the one or more examples comprises a plurality of natural language queries and a corresponding plurality of formal language queries.

In some embodiments, the prompt further comprises at least one of: a maximum number of tokens to generate for the formal language query and a hyperparameter specifying a temperature value for generating the formal language query. In some embodiments, the method further includes identifying one or more keywords in the natural language query; and identifying, in a set of data comprising a plurality of examples for generating formal language queries, based on the one or more keywords, the one or more examples pertaining to the request.

In some embodiments, the method further includes identifying one or more values of a chosen similarity metric between word embeddings comprised by a set of word embeddings corresponding to the natural language query; and identifying, in a set of data comprising a plurality of examples for generating formal language queries, based on the one or more cosine similarities, the one or more examples pertaining to the request.

In some embodiments, the formal language query is to be executed to identify: (i) a malicious activity relating to the plurality of computing resources, (ii) a potential attack path relating to the plurality of computing resources, or (iii) a security-related vulnerability relating to the plurality of computing resources.

In some embodiments, a computer-readable storage medium (which may be a non-transitory computer-readable storage medium, although the invention is not limited to that) stores instructions which, when executed, cause a processing device to perform operations comprising a method according to any embodiment or aspect described herein.

In some embodiments, a system comprises: a memory device; and a processing device operatively coupled with the memory device to perform operations comprising a method according to any embodiment or aspect described herein.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system for artificial intelligence-based query generation to search cybersecurity data, in accordance with at least one embodiment.

FIG. 2A illustrates another example system for artificial intelligence-based query generation to search cybersecurity data, in accordance with at least one embodiment.

FIG. 2B illustrates another example system for artificial intelligence-based query generation to search cybersecurity data, in accordance with at least one embodiment.

FIG. 3 depicts an example user interface (UI) for artificial intelligence-based query generation, in accordance with at least one embodiment.

FIG. 4 depicts a flow diagram of an example method of artificial intelligence-based query generation to search cybersecurity data, in accordance with at least one embodiment.

FIG. 5 illustrates an example artificial intelligence (AI) subsystem for artificial intelligence-based query generation to search cybersecurity data, in accordance with at least one embodiment.

FIG. 6 is a block diagram illustrating an exemplary computer system, in accordance with at least one embodiment of the present disclosure.

### DETAILED DESCRIPTION

Computing resources, such as servers, data centers, computing devices, and cloud computing resources, can be susceptible to malicious activity (e.g., malware, network-based attacks). Examples of malicious activity include installation or operation of malware (e.g., malicious software), accessing or attempting to access computing resources without permission or authorization, modifying or exfiltrating data stored on computing resources without permission or authorization, exhausting computing resources (e.g., a denial-of-service attack), and other forms of unwanted activity. Malicious activity is often problematic for owners and operators of computing resources because the malicious activity can lead to interruption or inefficient operation of computing resources, or, in extreme cases, substantial financial loss and liabilities. Malware is used herein as an example of malicious activity, but malicious activity often involves many other components such as those mentioned above, which are also within the scope of the present disclosure.

A data analytics platform can provide services for detecting malicious activity with respect to computing resources, enabling timely mitigation before the malicious activity causes significant harm. For example, a data analytics platform can receive cybersecurity data from computing resources (e.g., event logs) and analyze the cybersecurity data for signs of malicious activity. The event logs can be generated in response to certain actions that occur with respect to the computing resources. The actions can include an operating system event, an error generated by a software application, or other actions that can occur with respect to the computing resources.

An event log can come in many formats and take a variety of forms, depending on the vendor and/or model of a computing resource that generated the event log or a type of event represented by the event log. In some cases, two different devices or applications that perform similar functionality can generate event logs in very different formats for the same or similar events.

In order for a data analytics platform to intelligently analyze event logs, the data analytics platform can require that each event log be transformed into a predefined schema (also referred to herein as a “unified data model”).

The data analytics platform can use event log parsers (also referred to herein as “parsers”) to convert event logs to the predefined schema. A parser can include a piece of software configured to accept an event log as input and convert the event log into a data object that complies with the predefined schema.

In some instances, the data analytics platform can allow users to query the event logs (e.g., the event logs converted to the predefined schema) in order to search the event logs for potential malicious activity. However, the data analytics platform may require users to write queries using a domain-specific query language corresponding to the predefined schema. For example, a query written in a predefined schema for a particular data analytics platform can be the following:
metadata.vendor_name=“Vendor Name” AND
metadata.event_type=“Event Type” AND
target.resource.resource_type=“Resource Type” AND
target.resource.name=“Resource Name”

This example can be used to search for events of a particular “event_type” that are related to a particular “resource_name” of a particular “resource_type” associated with a particular “vendor_name” that was created with respect to a particular “resource name.” However, writing queries using predefined schemas, such as the above, can be challenging for users who may not be familiar with domain-specific query language and/or the predefined schema of a particular data analytics platform. This can hinder the users' ability to detect and respond to potential malicious activity in event logs. In turn, the inability to detect and respond to potential malicious activity in event logs can lead to security breaches or cyberattacks on particular computing resources, exposing these computing resources to downtime or malware.

Aspects of the present disclosure address the above and other deficiencies by generating artificial intelligence-based domain-specific queries (e.g., formal language queries) to search data (e.g., cybersecurity data) for malicious activity relating to computing resources. For example, a system (e.g., a data analytics system) can receive a natural language query (e.g., via a graphical user interface (GUI)) to generate a formal language query language in order to search cybersecurity data (e.g., event logs) from a set of computing resources of one or more entities. In some embodiments, the request can be in the form of a statement or a question, each of which can be expressed as a partial or complete sentence in a natural language.

In response to receiving the request, the natural language query can be provided as input to a trained artificial intelligence (AI) model, such as a generative AI model. The AI model can provide one or more outputs, where the one or more outputs include (i) a set of queries, and (ii) for each query of the set of queries, an indicator of a level of confidence that the query is a query that reflects the natural language query input. The data analytics system can identify, among the set of queries, a query having an indicator of a level of confidence that satisfies a confidence criterion (e.g., the indicator of the level of confidence that is the largest among the set of queries, or the indicator of the level of confidence that is greater than or equal to a threshold confidence level associated with the confidence criterion). In response to identifying the query having the indicator of the level of confidence that satisfies the confidence criterion, the data analytics system can cause the query to be executed to search the cybersecurity data to identify potential malicious activity relating to the set of computing resources.

Advantages of the disclosed embodiments over the existing technology include but are not limited to providing a system that can automatically generate, using a natural language query as input, a query expressed in a domain-specific query language, without prior knowledge of the domain-specific query language from users. Instead, an AI model can generate a set of queries and identify, for each query of the set of queries, an indicator of a level of confidence that the query is a query expressed in the domain-specific query language. As such, the system reduces the time a user spends writing a query in a domain-specific query language for a particular data analytics platform and improves the accuracy of writing an effective query to search cybersecurity data for potential malicious activity, resulting in reduced misuse of computing resources. There can thus be an overall improvement in the efficiency, latency, and effectiveness of searching cybersecurity data for potential malicious activity. Further, by being able to search the cybersecurity data more effectively to identify potential malicious activity, users and/or a data analytics platform can take actions to prevent the malicious activity or reduce its impact on computing resources, thus reducing or eliminating the effects of the malicious activity.

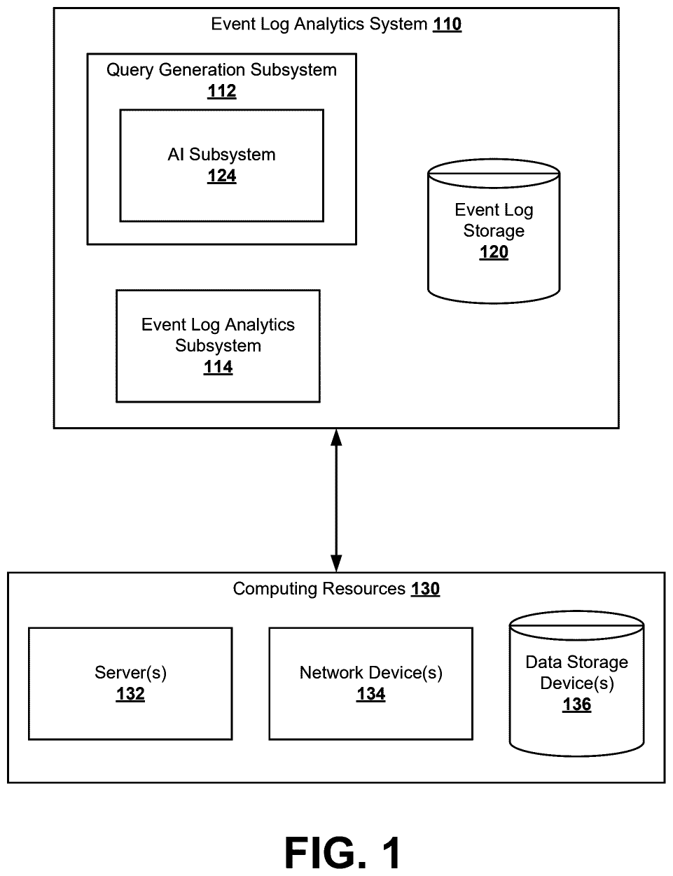

FIG. 1 is a schematic block diagram illustrating an example system 110 in which some aspects of the present disclosure can be implemented, in accordance with various embodiments. The system 110 can be an event log analytics system 110. The event log analytics system 110 can include a query generation subsystem 112, an event log analytics subsystem 114, and/or an event log storage 120. The query generation subsystem 112 can include an artificial intelligence (AI) subsystem 124. The event log analytics system 110 can include computing resources 130.

In some implementations, the event log analytics system 110 can include a computing network that includes one or more computing devices which may be employed to receive event log data from computing resources 130, use parsers and/or parser extensions to convert the event log data into a predefined format (e.g., a domain-specific query language), and perform data analytics operations on the event log data in the predefined format. The computing resources 130 can be part of a system that is external to the event log analytics system 110. The computing resources 130 can include one or more servers 132, one or more network devices 134, and/or one or more data storage devices 136. The event log analytics system 110 and the computing resources 130 can be in data communication with each other over a data network.

In some implementations, a computing device can include a physical computing device or can include a virtualized component, such as a virtual machine (VM) or a container. A computing device can include an instance of a computing device. An instance of a computing device can include a spun-up instance that may not be specific to any computing device. In some implementations, a VM can include a system virtual machine, which can include a VM that emulates an entire physical computing device. A VM can include a process virtual machine, which can include a VM that emulates an application or some other software. A container can include a computing environment that logically surrounds one or more software applications independently of other applications executing in the computing environment.

In some cases, the event log analytics system 110 can include a cloud computing system. A cloud computing system can include one or more computing devices (or portions of cloud computing devices) provided to an end user by a cloud provider. An end user of the environment can utilize a portion of the cloud computing system to host content for use or access by other parties or perform other computational tasks. In some implementations, the cloud computing system can be configured to allow the end user to use a portion of a computing device (e.g., only certain hardware, software, or other computer system resources). The cloud computing environment can include a private cloud, a public cloud, or a hybrid cloud. The cloud computing environment can provide infrastructure-as-a-service (IaaS), platform-as-a-service (PaaS), or software-as-a-service (SaaS) computing. The cloud computing environment can provide serverless computing.

In one implementation, the query generation subsystem 112 can include one or more software applications configured to translate natural language queries to queries expressed in the predefined formal language (e.g., the domain-specific query language). The query generation subsystem 112 can use one or more AI models of the AI subsystem 124 to generate the formal language queries. A user of the computing resources 130 can use a user interface on a computing device of the computing resources 130 that is in data communication with the query generation subsystem 112 to cause the query generation subsystem 112 to generate the queries.

In one implementation, the AI subsystem 124 can include one or more software applications configured to train and/or execute one or more AI models. An AI model can be configured to generate the queries expressed in the domain-specific query language. For example, the AI model can identify, based on a natural language query provided as input, a set of queries, and, for each query of the set of queries, an indicator of a level of confidence that the query includes a query expressed in the domain-specific query language. The AI model can perform other operations related to generating the queries. Further details regarding the AI subsystem 124 are described herein.

The event log analytics subsystem 114 can include one or more software applications configured to perform data analytics operations and other operations on the event log data. A user of the computing resources 130 can employ a user interface of a computing device of the computing resources 130 that is in data communication with the event log analytics subsystem 114 to view the results of the data analytics, execute queries, and perform other operations.

In some implementations, the event log storage 120 can include a data store. A data store can include a physical storage medium that can include volatile storage (e.g., random access memory (RAM), etc.) or non-volatile storage (e.g., a hard disk drive (HDD), flash memory, etc.). A data store can include a file system, a database, or some other software configured to store data.

In one implementation, the event log storage 120 can include a data store configured to store event log data. The stored event log data can include event logs prior to being operated on by the query generation subsystem 112 (sometimes referred to, herein, as “raw event logs”) or can include event logs in a predefined format (e.g., event logs that comply with the predefined schema of the event log analytics system 110). For example, the query generation subsystem 112 can include one or more software applications configured to perform one or more pre-processing operations to convert the raw event logs to a predefined schema (e.g., the unified data model). For example, the one or more pre-processing operations can include performing data cleaning, normalization, and/or normalization of the raw event logs. The one or more pre-processing operations can further include mapping one or more elements of the raw event logs to one or more elements of the predefined schema. The mapping between the one or more elements of the raw event logs and the one or more elements of the predefined schema can be stored in the event log storage 120. The event log storage 120 can provide the converted event log data in the predefined format to the event log analytics subsystem 114 for analysis.

In one or more implementations, the computing resources 130 can include a computing network. The computing resources 130 can include a computing network operated by a customer of the entity that operates the event log analytics system 110 and provides event log analytics services to the customer. The computing resources 130 can include one or more servers 132. A server 132 can include a computing device, including a physical computing device or a VM. The computing resources 130 can include one or more network devices 134. A network device 134 can include a switch, router, hub, gateway, wireless access point, bridge, modem, repeater, or other network devices. A network device 134 can help provide data communication between the one or more servers 132, between other devices of the computing resources 130, or between a computing device external to the computing resources 130 and a device of the computing resources 130. The computing resources 130 can include one or more data storage devices 136. A data storage device 136 can include a data store. One or more servers 132 or other computing devices of the computing resources 130 can store data on the one or more data storage devices 136 or retrieve data from the one or more data storage devices 136.

In one or more implementations, a computing network of the event log analytics system 110 or the computing resources 130 can include one or more computing devices in data communication with each other over a data network. The data network can include a local area network (LAN), wide area network (WAN), a virtual private network (VPN), or some other data network. The data network can include network devices, including switches, routers, hubs, gateways, wireless access points, bridges, modems, repeaters, or other network devices.

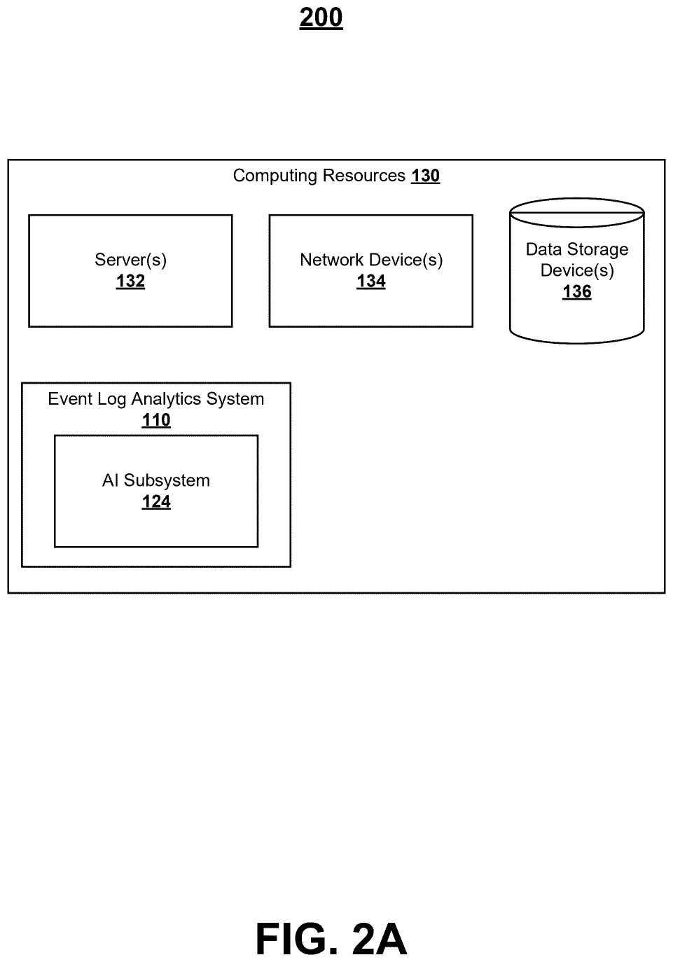

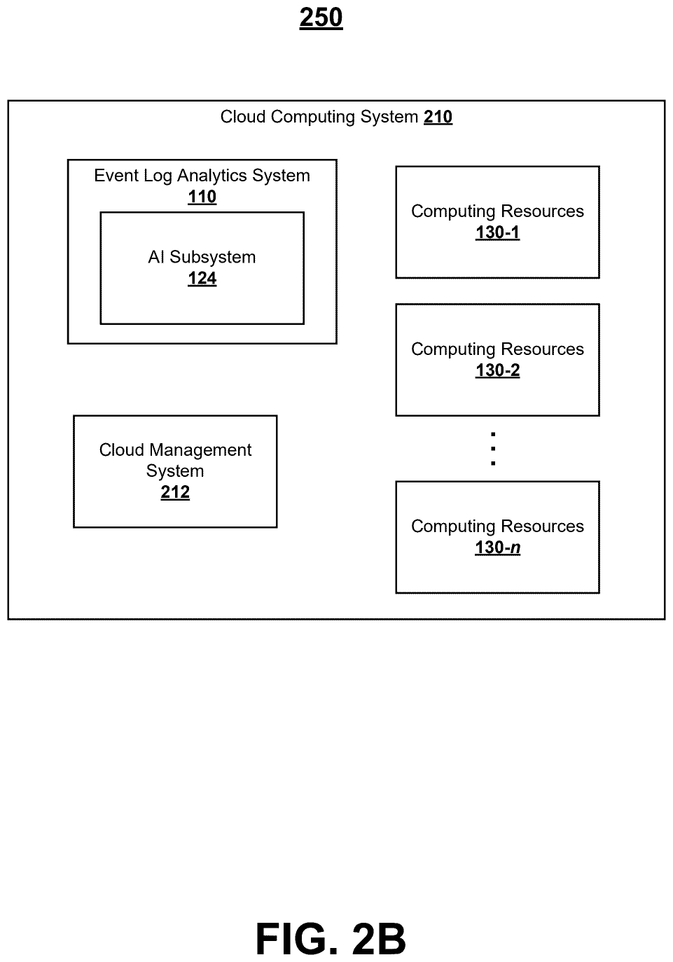

In some implementations, the event log analytics system 110 and the computing resources 130 can be separate computing networks and can communicate with each other over a data network. However, as seen in the example system 200 of FIG. 2A, in certain implementations, the computing resources 130 can include the event log analytics system 110. For example, the components of the event log analytics system 110 can be installed on one or more computing devices of the computing resources 130. The event log analytics system 110 can provide its functions locally to the computing resources 130. As seen in the example system 250 of FIG. 2B, in one or more implementations, a cloud computing system 210 can include the event log analytics system 110 and one or more sets of computing resources 130-1, . . . , 130-n. The one or more sets of computing resources 130-1, . . . , 130-n can be cloud computing environments provided by the cloud provider of the cloud computing system 210, and the cloud provider can operate the event log analytics system 110 and allow the one or more sets of computing resources 130-1, . . . , 130-n to use the event log analytics system's 110 functionality. The cloud computing system 210 can include a cloud management system 212, which can include one or more computing devices or software configured to manage the cloud computing system 210, including provisioning one or more sets of computing resources 130-1, . . . , 130-n to users or coordinate usage of the event log analytics system 110 by the one or more sets of computing resources 130-1, . . . , 130-n.

In implementations of the disclosure, a “user” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether event log analytics system 110 collects user information (e.g., information about a user's social network, social actions or activities, profession, a user's preferences, or a user's current location), or to control whether and/or how to receive content from the event log analytics system 110 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the event log analytics system 110.

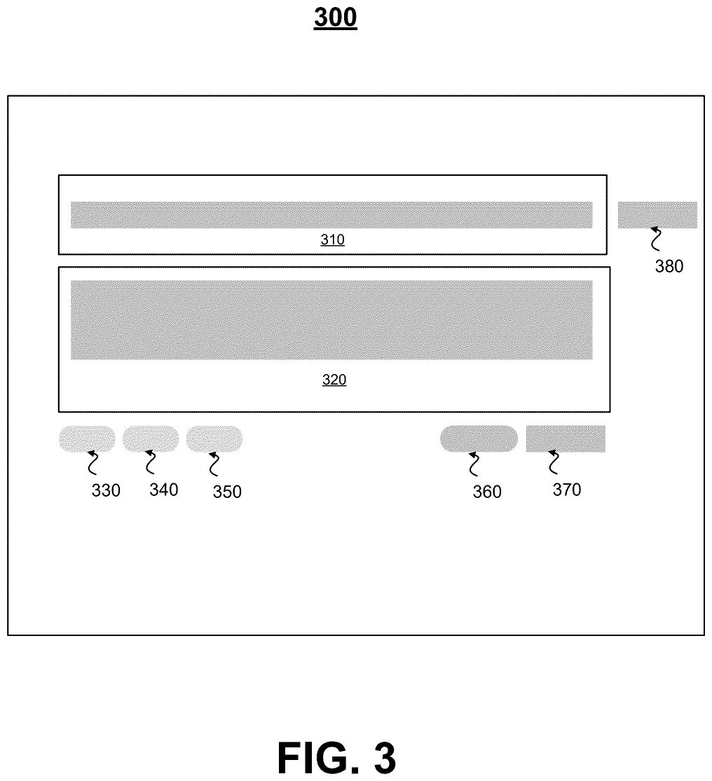

FIG. 3 depicts an example user interface (UI) for domain-specific query generation, in accordance with at least one embodiment. FIG. 3 can include a UI 300 provided by an application of an event log analytics system (e.g., the event log analytics system 110 of FIG. 1). The application can include a web browser application, a mobile application, a desktop application, or the like. User interaction with various elements of the UI 300 of FIG. 3 can cause changes to the UI elements presented. Various interactions between the UI 300 and UI elements presented in FIG. 3 are possible (e.g., interacting with an element of a first UI layout can cause a transition to a second UI layout), and any transition between sample UI, similar UI, inclusion of similar UI elements, etc., are within the scope of this disclosure.

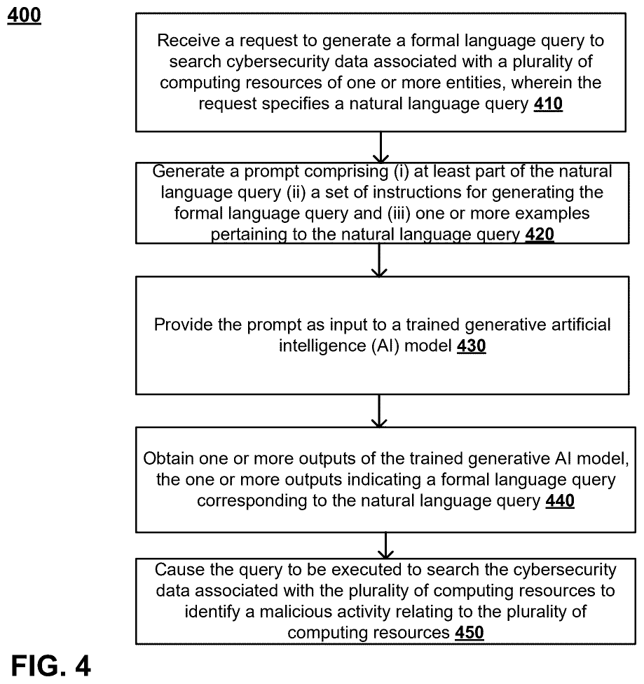

In some embodiments, UI 300 can include a display area 310 and a display area 320. Display area 310 can be an area for a user to request a query generated in a domain-specific query language, as described with respect to FIG. 4. For example, the display area 310 can include a text box for the user to input a natural language query. In some embodiments, the display area 310 can include a drop-down menu that identifies one or more previous natural language queries requested (e.g., by the user or another user) that can be selectable. The one or more previous natural language queries can be stored, for example, in the event log storage 120 of FIG. 1. In some embodiments, in response to inputting the natural language query, the user can select one or more UI elements presented in the UI 300 to request to generate the query in the domain-specific query language based on the inputted natural language query. For example, UI element 380 illustrated in FIG. 3 can be a UI element that is selectable to generate the query. In some embodiments, the UI element 380 can be a button. In some embodiments, the UI element 380 can be labeled with text that indicates a purpose of the UI element 380, e.g., “Generate Query.” In some embodiments, the UI element 380 can be presented in the display area 310. In some embodiments, the UI element 380 can be presented in another display area (e.g., the display area 320 or another display area in the UI 300).

In some embodiments, the display area 320 can be an area for presenting the generated query. For example, the display area 320 can include a text box to display the generated query. In some embodiments, the display area 320 can be of a larger size than the display area 310. In some embodiments, the display area 320 can be of a smaller size than the display area 310. In some embodiments, the display area 320 and the display area 310 can be the same size. In some embodiments, the display area 320 can be presented in the UI below the display area 310. In some embodiments, the display area 320 can be presented in the UI above the display area 310. In some embodiments, the display area 320 can be presented in the UI adjacent to the display area 310. In some embodiments, the display area 320 can be presented in another window presented in the UI.

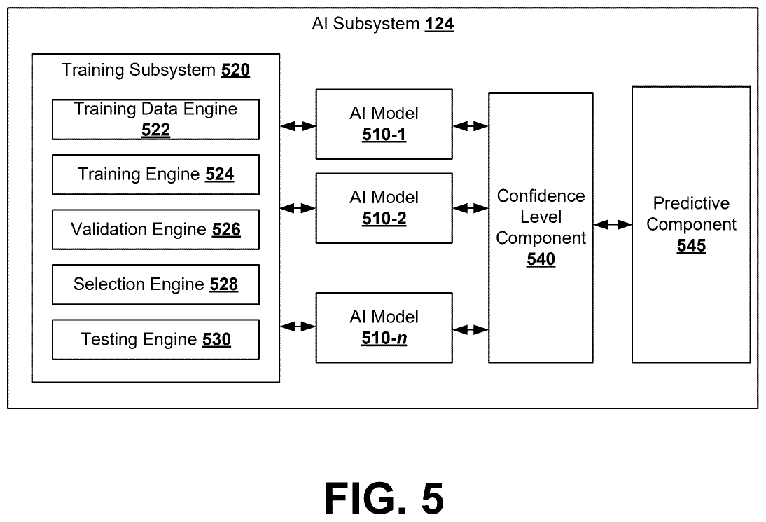

In some embodiments, the UI 300 can include one or more additional UI elements, e.g., UI element 330, 340, 350, 360, 370. One or more of the additional UI elements can be selectable (e.g., by a user) to provide feedback on the generated query. For example, the one or more additional UI elements can be a text box for the user to input the feedback. In another example, the one or more additional UI elements can be a “thumbs up” and/or “thumbs down” button, where a selection of the “thumbs up” button can indicate a positive feedback on the generated query and a selection of the “thumbs down” button can provide negative feedback on the generated query. In some embodiments, the feedback can be provided to improve the one or more outputs of the AI model 510, as described in more detail with respect to FIG. 5.

In some embodiments, one or more of the additional UI elements can be selectable to modify the generated query and/or to provide feedback on the generated query. For example, the one or more of the additional UI elements selectable to modify the generated query and/or provide feedback on the generated query can include a button which can be selected to enable the generated query to be editable (e.g., by a user). For example, in response to the button being selected, the generated query displayed in the text box in the display area 320 can be editable to modify the generated query (e.g., by adding, deleting, changing one or more portions of the generated query). In some embodiments, the modified query can be provided as feedback to improve the one or more outputs of the AI model 510, as described in more detail with respect to FIG. 5. In some embodiments, the one or more of the additional UI elements selectable to modify the generated query can be labeled with text that indicates a purpose of the one or more of the additional UI elements, e.g., “Rewrite.”

In some embodiments, one or more of the additional UI elements can be selectable to run the generated query. In some embodiments, the one or more of the additional UI elements selectable to run the generated query can be labeled with text that indicates a purpose of the one or more of the additional UI elements, e.g., “Execute.”

In some embodiments, one or more of the additional UI elements can be selectable to save the generated query. In some embodiments, the one or more of the additional UI elements selectable to save the generated query can be labeled with text that indicates a purpose of the one or more of the additional UI elements, e.g., “Save.”

In some embodiments, one or more of the additional UI elements can be selectable to execute the generated query. In some embodiments, the one or more of the additional UI elements selectable to execute the generated query can be labeled with text that indicates a purpose of the one or more of the additional UI elements, e.g., “Execute.”

In some embodiments, the one or more additional UI elements can be presented in the display area 310, the display area 320, and/or another display area in the UI 300.

FIG. 4 depicts a flow diagram of an example method 400 of artificial intelligence-based query generation to search cybersecurity data, in accordance with at least one embodiment. Method 400 can be performed by processing logic that can include hardware (circuitry, dedicated logic, etc.), software (e.g., instructions run on a processing device), or a combination thereof. In at least one implementation, some or all of the operations of method 400 can be performed by one or more components of system 100 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 410, processing logic can receive a request to generate a formal language query (e.g., a query expressed in a domain-specific query language) to search cybersecurity data associated with a set of computing resources (e.g., the computing resources 130 of FIG. 1) of one or more entities. The one or more entities can include one or more organizations, one or more users, etc., and the set of computing resources may include one or more computing devices, networks, databases, and/or the like associated with the one or more entities. In some embodiments, the request can specify a natural language query that pertains to the cybersecurity data associated with the set of computing resources. In some embodiments, receiving the request can include receiving a selection (e.g., from a user of a computing resource of the set of computing resources and/or a user of a data analytics platform, such as the event log analytics system 110 of FIG. 1) of a user interface (UI) element presented in a display area (e.g., a first display area) of a UI (e.g., the UI 300 of FIG. 3).

At block 420, the processing logic can generate a prompt. In some embodiments, the prompt can include (i) at least a part of the natural language query specified by the request (e.g., the request received at block 410), (ii) a set of instructions for generating the formal language query, and/or (iii) one or more examples pertaining to the natural language query specified by the request (e.g., the request received at block 410). As described with respect to FIG. 5, the set of instructions can indicate to an AI model (e.g., the AI model 510) to generate a query that translates the natural language query into a formal language query.

In some embodiments, the one or more examples pertaining to the natural language query specified by the request can be selected from a set of data (e.g., a set of data stored in the event log storage 120 of FIG. 1) that includes a set of examples for generating formal language queries (e.g., queries expressed in the domain-specific query language). For example, the set of examples can include a set of natural language queries and a corresponding set of translated queries expressed in the domain-specific language. Each example can include a natural language query and a corresponding translated query expressed in the domain-specific language. In some embodiments, each example of the set of examples can be mapped to one or more keywords of a set of keywords. The set of keywords can be stored in the event log storage 120 of FIG. 120. In some embodiments, to identify the one or more examples, the processing logic can identify one or more keywords in the natural language query specified by the request received at block 410 of FIG. 4. The one or more keywords can be identified by comparing each string (e.g., word) in the natural language query to the one or more keywords in the set of keywords stored in the event log storage 120. In response to identifying the one or more keywords in the natural language query, the processing logic can identify, from the set of data that includes the set of examples, the one or more examples of the set of examples that is mapped to the same or similar identified one or more keywords.

In some embodiments, the processing logic can identify one or more values of a chosen similarity metric corresponding to the natural language query. For example, the chosen similarity metric can be a term-frequency-inverse document frequency (TF-IDF) or the cosine similarity. For example, the processing language can translate the natural language query (e.g., the natural language query specified by the request) into a sequence (e.g., a set) of embeddings (e.g., word embeddings). The processing logic can identify the one or more examples that have similar natural language queries based on the one or more values of the chosen similarity metric (e.g., a TF-IDF similarity and/or cosine similarity). For example, the processing logic can identify one or more TF-IDF similarities and/or one or more cosine similarities between the sequence of word embeddings. The processing logic can identify, in the set of data, one or more examples of the set of examples that is associated with the same or similar (e.g., above a similarity threshold) identified one or more TF-IDF similarities and/or one or more cosine similarities. In some embodiments, the similarity threshold can be a predefined value stored in a data structure (e.g., the event log storage 120 of FIG. 1). In some embodiments, the similarity threshold can be determined using experimental data and offline testing.

In some embodiments, the prompt can include contextual information pertaining to the natural language query specified by the request received at block 410 of FIG. 4. For example, the contextual information can include a time range that indicates a specific window of time that the cybersecurity data should be associated with, one or more examples of natural language queries pertaining to the request received at block 410 of FIG. 4 and corresponding translated queries expressed in the domain-specific language, a maximum number of tokens to generate for a set of queries, a hyperparameter value that specifies a temperature value for generating the set of queries), and/or user-specific (e.g., environmental) data that can specify event log sources and/or event types to which the user has access. The environmental data can be stored in a data structure, such as the event log storage 120. The temperature value specified by the hyperparameter value can be used to influence the level of randomness in the AI model 510's predicted outputs (e.g., in the AI model 510's query generation). For example, a high temperature value can increase the randomness in the AI model 510's predictions, and a low temperature value can reduce the randomness in the AI model 510's predictions.

At block 430, the processing logic can provide the prompt as input to a trained artificial intelligence (AI) model (e.g., one or more AI models 510-1, . . . , 510-n of FIG. 5). Referring to FIG. 5, FIG. 5 illustrates an example artificial intelligence (AI) subsystem for domain-specific query generation to search cybersecurity data, in accordance with at least one embodiment. As illustrated in FIG. 5, the AI subsystem 124 can include one or more AI models 510-1, . . . , 510-n. The AI subsystem 124 can include a training subsystem 520, which can include a training data engine 522, a training engine 524, a validation engine 526, a selection engine 528, and/or a testing engine 530. The AI subsystem 124 can include a confidence level component 540. The AI subsystem 124 can include a predictive component 545. In some embodiments, the AI subsystem 124 may not be part the query generation subsystem 112 and may instead be part of another system or sub-system or be an independent system, and can only include the training subsystem 520 that can train AI models 510-1, . . . , 510-n and provide them to the query generation subsystem 112, which can include the trained AI models 510-1, . . . , 510-n, and the confidence level component 540, and the predictive component 545.

In one embodiment, an AI model 510 can include one or more artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN can include adjusting the weights or other features of the ANN based on an output produced by the ANN during training.

An ANN can include, for example, a convolutional neural network (CNN), a recurrent neural network (RNN), or a deep neural network. A CNN, a specific type of ANN, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). A deep network can include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) can include a hierarchy of layers, where the different layers learn different levels of representations that correspond to different levels of abstraction. In deep learning, each level learns to transform its input data into a slightly more abstract and composite representation.

In one embodiment, an AI model 510 can include a generative AI model. A generative AI model can differ from a machine learning model due to the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

A generative AI model can also have the ability to capture and learn complex, high-dimensional structures of data. One aim of the generative AI model is to simulate the data distribution learned from the training dataset, thus allowing to generate new data points that possess the same characteristics as training data. In contrast, some machine learning models (e.g., that are not generative AI models) focus on optimizing the prediction of tasks based on existing data patterns from the training data.

In some embodiments, an AI model 510 can be trained on training data that includes a corpus of data. In some embodiments, the AI model 510 can be pre-trained on a corpus of data to create a foundational model, and afterwards fine-tuned on more data pertaining to a particular set of tasks for which the AI model 500 is intended to be used, in order to create a more task-specific, or targeted, model. The foundational model can first be pre-trained using a corpus of data that can include data in the public domain, licensed content, and/or proprietary content. Such a pre-training can be used by the AI model 510 to learn broad elements including, image or speech recognition, general sentence structure, common phrases, vocabulary, natural language structure, and other elements. In some embodiments, this first, foundational model can be trained using self-supervision, or unsupervised training on such datasets.

In an illustrative example, a training data engine 522 can initialize a training set, T, to null (e.g., { }). The training data engine 522 can add the training data to the training set T and can determine whether the training set T is sufficient for training the AI model 510. The training set T can be sufficient for training the AI model 510 if the training set Tincludes a threshold amount of training data, in some embodiments. In response to determining that the training set T is not sufficient for training, the training data engine 522 can identify additional data (e.g., as described above) to use as training data. In response to determining that the training set T is sufficient for training, the training data engine 522 can provide the training set T to the training engine 524.

The training engine 524 can train the AI model 510 using the training data (e.g., the training set T). The AI model 510 can refer to the model artifact that is created by the training engine 524 using the training data, where such training data can include training inputs and, in some implementations, corresponding target outputs (e.g., correct answers for respective training inputs). The training engine 524 can input the training data into the AI model 510 so that the AI model 510 can find patterns in the training data and configure itself based on those patterns.

Where the AI model 510 uses supervised learning, the training engine 524 can assist the AI model 510 in determining whether the AI model 510 maps the training input to the target output (the answer to be predicted or the ground truth). Where the AI model 510 uses unsupervised learning, the training engine 524 can input the training data into the AI model 510. The AI model 510 can configure itself based on the input training data, but since the training data may not include a target output, the training engine 524 may not assist the AI model 510 in determining whether the AI model 510 provided a correct output during the training process.

The validation engine 526 can validate a trained AI model 510 using a corresponding set of features of a validation set from the training data engine 522. The validation engine 526 can determine an accuracy of each of the trained AI models 510 based on the corresponding sets of features of the validation set. Where the training data may not include a target output, validating a trained AI model 510 can include obtaining an output from the AI model 510 and providing the output to another entity for evaluation. The other entity can include another AI model configured to evaluate the output of the AI model that is undergoing training. The other entity can include a human. The validation engine 526 can discard a trained AI model 510 that has an accuracy that does not meet a threshold accuracy or that otherwise fails evaluation. In some embodiments, the selection engine 528 can be capable of selecting a trained AI model 510 that has an accuracy that meets a threshold accuracy. In some embodiments, the selection engine 528 can be capable of selecting the trained AI model 510 that has the highest accuracy of multiple trained AI models 510. In some implementations, the selection engine 528 can receive input from another AI model 510 or a human and can select a trained AI model 510 based on the input.

The testing engine 530 can test a trained AI model 510 using a corresponding set of features of a testing set from the training data engine 522. For example, a first trained AI model 510 that was trained using a first set of features of the training set can be tested using the first set of features of the testing set. The testing engine 530 can determine a trained AI model 510 that has the highest accuracy or other evaluation of all of the trained AI models 510 based on the testing sets.

In some embodiments, the AI model 510 can then be further trained or fine-tuned on proprietary data. In some embodiments, the second portion of training, including fine-tuning, can be unsupervised, supervised, reinforced, or any other type of training. In some embodiments, this second portion of training can include some elements of supervision, including learning techniques incorporating human or machine-generated feedback, undergoing training according to a set of guidelines, or training on a previously labeled set of data, etc. In an example associated with reinforcement learning, the outputs produced by the AI model 510 while training can be ranked by a user, according to a variety of factors, including accuracy, helpfulness, veracity, acceptability, or any other metric useful in the fine-tuning portion of training. In this manner, the AI model 510 can learn to favor these and any other factors relevant to users when generating a response. Further details regarding training are provided below.

In some embodiments, an AI model 510 can include one or more pre-trained models, or fine-tuned models. In a non-limiting example, in some embodiments, the goal of the “fine-tuning” can be accomplished with a second, third, or any number of additional models. For example, the outputs of the pre-trained model can be input into a second AI model 510 that has been trained in a similar manner as the “fine-tuned” portion of training. In such a way, two more AI models 510 can accomplish work similar to one AI model 510 that has been pre-trained, and then fine-tuned.

As indicated above, an AI model 510 can be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including RNNs, CNNs, or transformer networks.

In some embodiments, a generative AI model 510 can include an LLM that has been trained using few-shot learning techniques. Few-shot learning can be used to train an LLM to perform a task by generalizing from a limited (e.g., small) number of examples at inference time (e.g., when the LLM is used to perform a task (e.g., generate formal language queries)). For example, the LLM can be provided with one or more examples that are relevant to a natural language query specified in a request (e.g., the request received at block 410 of FIG. 4) to show the LLM how to generate a formal language query from the natural language query specified in the request. In some embodiments, few-shot learning can include constructing a prompt, as described in detail with respect to block 420 of FIG. 4. The prompt can include a current time at which the prompt is provided to the LLM, a set of instructions to the LLM to generate the formal language query, one or more examples pertaining to a natural language query specified in a request, at least a part of the natural language query specified in the request, and/or user-specific (e.g., environmental) data that can specify event log sources and/or event types to which the user has access. In some embodiments, the LLM can include generative AI functionality. In such embodiments, the AI model 510 can generate new content based on provided input data (e.g., the prompt). The generative AI model 510 can be supported by a prompt subsystem (not shown), which can reside on the AI subsystem 124. The prompt subsystem can be configured to perform automated identification of, and facilitate retrieval of, relevant and timely contextual information for efficient and accurate processing of prompts by the AI model 510. The prompt subsystem can be in communication with the event log storage 120. Communications between the prompt subsystem and the predictive component 545 can be facilitated by a generative model application programming interface (API), in some embodiments. Communications between the prompt subsystem and event log storage 120 can be facilitated by a data management API. In additional or alternative embodiments, the generative model API can translate prompts generated by the prompt subsystem into unstructured natural-language format and, conversely, translate responses received from the AI model 510 into any suitable form (e.g., including any structured proprietary format as may be used by the prompt subsystem).

In some embodiments, the prompt subsystem can include a prompt analyzer to support various operations of the AI subsystem 124. For example, the prompt analyzer can receive an input (e.g., the natural language query specified by the request received at block 410 of FIG. 4) and generate one or more large language model (LLM) prompts to the generative AI model 510. In some embodiments, the prompt analyzer can analyze the natural language query and form a request for relevant contextual data (e.g., a time range that indicates a specific window of time that the cybersecurity data should be associated with, one or more examples pertaining to the natural language query, as described with respect to block 420 of FIG. 4, a maximum number of tokens to generate for a set of queries, a hyperparameter value that specifies a temperature value for generating the set of queries), and/or user-specific (e.g., environmental) data from the event log storage 120, which can then supply such data. The prompt analyzer can then generate a prompt to the generative AI model 510 that includes at least a part of the natural language query, a set of instructions for generating a formal language query, and the contextual data. The temperature value can be used to influence the level of randomness in the AI model 510's predicted outputs (e.g., in the AI model 510's query generation). For example, a high temperature value can increase the randomness in the AI model 510's predictions, and a low temperature value can reduce the randomness in the AI model 510's predictions.

The prompt subsystem can provide the prompt to the predictive component 545. The predictive component 545 can input the prompt into the generative AI model 510. The generative AI model 510 can generate a set of queries (e.g., formal language queries) and, for each query of the set of queries, an indicator of a level of confidence that the query is a query that reflects the natural language query (e.g., the natural language query specified by the request received at block 410 of FIG. 4).

Referring back to FIG. 4, at block 440, the processing logic can obtain one or more outputs of the trained AI model, as described with respect to FIG. 5. In some embodiments, the one or more outputs can indicate a formal language query that corresponds to the natural language query requested at block 410. In some embodiments, the one or more outputs include (i) a set of formal language queries, and (ii) for each query of the set of queries, an indicator of a level of confidence that the query is a query that accurately reflects the natural language query. In embodiments, the processing logic can identify, among the set of queries, a query having an indicator of a level of confidence that satisfies a confidence criterion. In some embodiments, satisfying the confidence criterion can include identifying, among the set of queries, the indicator of the level of confidence for each query that is equal to or greater than a threshold confidence level associated with the confidence criterion. In some embodiments, the confidence criterion and/or the threshold confidence level can be stored in the event log storage 120 of FIG. 1. In some embodiments, the processing logic can cause the identified query to be presented in a display area (e.g., a second display area) of a UI (e.g., the UI 300 of FIG. 3). In some embodiments, in response to causing the identified query to be presented in the display area of the UI, the processing logic can receive a request to provide feedback on the identified query. For example, the processing logic can receive a selection (e.g., from the user) of a user interface (UI) element presented in a display area of the UI (e.g., the UI 300 of FIG. 3). In some embodiments, the feedback can include a “thumbs up” and/or “thumbs down,” where “thumbs up” can indicate positive feedback on the identified query and “thumbs down” can indicate negative feedback on the identified query. In some embodiments, the feedback can be used to improve the one or more outputs of the AI model 510. For example, the feedback can be used to evaluate and/or adjust and/or add examples used in constructing the prompt for training the AI model 510 using few-shot learning techniques, as discussed in detail above. In some embodiments, in response to causing the identified query to be presented in the display area of the UI, the processing logic can receive a request to modify the identified query. For example, the processing logic can receive a selection (e.g., from the user) of a user interface (UI) element (e.g., the UI element labeled “Rewrite”, as described with respect to FIG. 3) presented in a display area of the UI (e.g., the UI 300 of FIG. 3). In some embodiments, the request to modify the identified query can include a request to modify one or more portions of the identified query. In some embodiments, the modified one or more portions of the identified query can be provided as feedback to improve the one or more outputs of the AI model 510. For example, the processing logic can detect changes (e.g., automatically) between the identified query and the modified one or more portions of the identified query. The detected changes between the identified query and the modified one or portions of the identified query can be provided as feedback to improve the one or more outputs of the AI model 510. For example, the detected changes can be used to evaluate and/or adjust and/or add examples used in constructing the prompt for training the AI model 510 using few-shot learning techniques, as discussed in detail above.

In some embodiments, the processing logic can perform a validation check of the identified query (e.g., to determine that the identified query is written in the formal language query and/or that the identified query accurately reflects the natural language query requested at block 410). In some embodiments, in response to determining that the identified query satisfies the validation check (e.g., that the identified query is written in the formal language query and/or that the identified query accurately reflects the natural language query requested at block 410), the processing logic can cause the identified query to be presented in the display area of the UI, as discussed above. In some embodiments, in response to determining that the identified query does not satisfy the validation check (e.g., that the identified query is not written in the formal language query and/or that the identified query does not accurately reflect the natural language query requested at block 410), the processing logic can send an indication of an error (e.g., an error message specifying that the identified query does not satisfy the validation check) and a request to correct (e.g., modify) the identified query to the AI model 510. For example, the error message can be used to evaluate and/or adjust and/or add examples used in constructing the prompt for training the AI model 510, as discussed in detail above.

At block 450, the processing logic can cause the formal language query (e.g., the query identified at block 440) to be executed to search the cybersecurity data associated with the set of computing resources. For example, causing the formal language query to be executed can include communicating the formal language query to a database client, which can send the formal language query to a database server to retrieve results (e.g., one or more records pertaining to the cybersecurity data) of the executed formal language query. The processing logic can receive the results of the executed formal language query from the database client. The processing logic can use the received results to search the cybersecurity data to identify one or more of: a malicious activity relating to the set of computing resources, a potential attack path relating to the set of computing resources, and/or a security-related vulnerability relating to the set of computing resources. In some embodiments, causing the formal language query to be executed can include receiving a request to execute the formal language query. For example, the processing logic can receive a selection (e.g., from the user) of a user interface (UI) element presented in a display area of the UI (e.g., the UI 300 of FIG. 3). In some embodiments, in response to causing the formal language query to be executed, one or more event logs can be returned that pertain to the formal language query. In some embodiments, the user can search the one or more event logs for malicious activity relating to the set of computing resources, a potential attack path relating to the set of computing resources, and/or one or more security-related vulnerabilities relating to the set of computing resources.

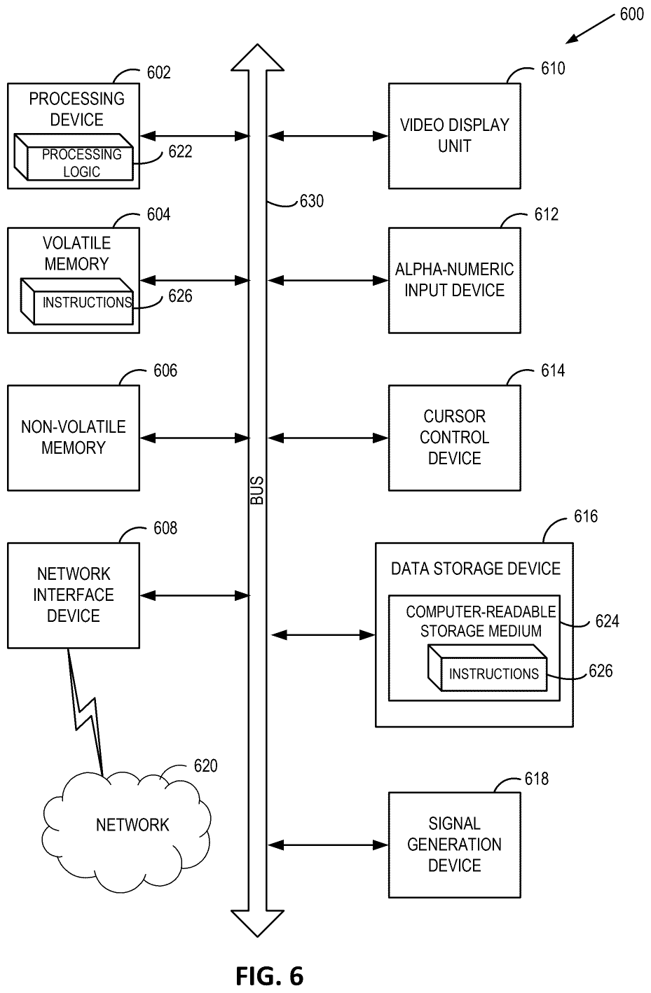

FIG. 6 is a block diagram illustrating an example computer system 600, in accordance with implementations of the present disclosure. The computer system can be a computing device or other device discussed herein. The computer system 600 can be the event log analytics system 19, the query generation subsystem 112, the event log analytics subsystem 114, the event log storage 120, the AI subsystem 124, a server 132, a network device 134, or a data storage device 136 of FIG. 1. The computer system 600 can be a cloud management system 212 of FIG. 2B. The computer system 600 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a volatile memory 604 (e.g., read-only memory (ROM), flash memory, dynamic random access memory (DRAM) such as synchronous DRAM (SDRAM), double data rate (DDR SDRAM), or DRAM (RDRAM), etc.), a non-volatile memory 606 (e.g., flash memory, static random access memory (SRAM), etc.), and a data storage device 616, which communicate with each other via a bus 630.

The processing device 602 represents one or more general-purpose processing devices such as a microprocessor, CPU, GPU, or the like. More particularly, the processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 can also be one or more special-purpose processing devices such as an ASIC, a field programmable gate array (FPGA), a digital signal processor (DSP), network processor, or the like. The processing device 602 is configured to execute instructions 626 (e.g., for performing the method 400) for performing the operations discussed herein.

The computer system 600 can further include a network interface device 608. The network interface device 608 can assist in data communication between computing devices. The computer system 600 also can include a video display unit 610 (e.g., a liquid crystal display (LCD) or a cathode ray tube (CRT)), an input device 612 (e.g., a keyboard, and alphanumeric keyboard, a motion sensing input device, touch screen), a cursor control device 614 (e.g., a mouse), and a signal generation device 618 (e.g., a speaker).

The data storage device 616 can include a non-transitory machine-readable storage medium 624 (also computer-readable storage medium) on which is stored one or more sets of instructions 626 (e.g., for generating domain-specific queries to search cybersecurity data and other functionality disclosed herein) embodying any one or more of the methodologies or functions described herein. The instructions 626 can also reside, completely or at least partially, within the volatile memory 604 and/or within the processing device 602 during execution thereof by the computer system 600, the volatile memory 604 and the processing device 602 also constituting machine-readable storage media. The instructions 626 can further be transmitted or received over a network 620 via the network interface device 608.

In one implementation, the instructions 626 include instructions for generating domain-specific queries to search cybersecurity data. While the computer-readable storage medium 624 (machine-readable storage medium) is shown in an example implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “displaying”, “moving”, “adjusting”, “replacing”, “determining”, “playing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the method 400 is depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation,” “an implementation,” “some implementations,” “one embodiment,” “an embodiment,” or “some embodiments” mean that a particular feature, structure, or characteristic described in connection with the implementation or embodiment is included in at least one implementation or embodiment. Thus, the appearances of the phrase “in one implementation” or “in an implementation” or other similar terms in various places throughout this specification are not necessarily all referring to the same implementation. In addition, the term “or” is intended to mean an inclusive “or” rather than an exclusive “or.” Moreover, the word “example” or a similar term are used herein to mean serving as an example, instance, or illustration. Any aspect or design described herein as an “example” is not necessarily to be construed as preferred or advantageous over other aspects or designs. Rather, use of the word “example” or a similar term is intended to present concepts in a concrete fashion.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

Implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving a request to generate a formal language query to search cybersecurity data associated with a plurality of computing resources of one or more entities, wherein the request specifies a natural language query pertaining to the cybersecurity data associated with the plurality of computing resources;
generating a prompt comprising: (i) at least part of the natural language query from the request to generate the formal language query, (ii) a set of instructions for generating the formal language query, and (iii) one or more examples pertaining to the natural language query;
providing the prompt as input to a trained generative artificial intelligence (AI) model;
obtaining one or more outputs of the trained generative AI model, the one or more outputs indicating a formal language query corresponding to the natural language query; and
causing the formal language query to be executed to search the cybersecurity data associated with the plurality of computing resources.

2. The method of claim 1, further comprising:
providing a user interface (UI) comprising one or more UI elements for receiving the request to generate the formal language query, wherein the one or more UI elements is presented in a first area of the UL

3. The method of claim 2, further comprising:
causing the formal language query to be presented in a second area of the UL

4. The method of claim 2, wherein the UI comprises one or more additional UI elements for receiving the request to provide feedback on the formal language query.

5. The method of claim 2, further comprising:
receiving a request to modify the formal language query, wherein the UI comprises one or more additional UI elements for receiving the request to modify the formal language query.

6. The method of claim 1, wherein the one or more examples comprises a plurality of natural language queries and a corresponding plurality of formal language queries.

7. The method of claim 1, wherein the prompt further comprises at least one of: a maximum number of tokens to generate for the formal language query and a hyperparameter specifying a temperature value for generating the formal language query.

8. The method of claim 1, further comprising:
identifying one or more keywords in the natural language query; and
identifying, in a set of data comprising a plurality of examples for generating formal language queries, based on the one or more keywords, the one or more examples pertaining to the request.

9. The method of claim 1, further comprising:
identifying one or more values of a chosen similarity metric between word embeddings comprised by a set of word embeddings corresponding to the natural language query; and
identifying, in a set of data comprising a plurality of examples for generating formal language queries, based on the one or more cosine similarities, the one or more examples pertaining to the request.

10. The method of claim 1, wherein the formal language query is to be executed to identify: (i) a malicious activity relating to the plurality of computing resources, (ii) a potential attack path relating to the plurality of computing resources, or (iii) a security-related vulnerability relating to the plurality of computing resources.

11. A system comprising: a memory device; and
a processing device coupled to the memory device, the processing device to perform operations comprising:
receiving a request to generate a formal language query to search cybersecurity data associated with a plurality of computing resources of one or more entities, wherein the request
specifies a natural language query pertaining to the cybersecurity data associated with the plurality of computing resources;
generating a prompt comprising: (i) at least part of the natural language query from the request to generate the formal language query, (ii) a set of instructions for generating the formal language query, and (iii) one or more examples pertaining to the natural language query;
providing the prompt as input to a trained generative artificial intelligence (AI) model; obtaining one or more outputs of the trained generative AI model, the one or more outputs
indicating a formal language query corresponding to the natural language query; and
causing the formal language query to be executed to search the cybersecurity data associated with the plurality of computing resources.

12. The system of claim 11, wherein the processing device is to perform operations further comprising:
providing a user interface (UI) comprising one or more UI elements for receiving the request to generate the formal language query, wherein the one or more UI elements is presented in a first area of the UL

13. The system of claim 12, wherein the processing device is to perform operations further comprising:
causing the formal language query to be presented in a second area of the UL

14. The system of claim 12, wherein the UI comprises one or more additional UI elements for receiving the request to provide feedback on the formal language query.

15. The system of claim 11, wherein the prompt further comprises at least one of: a maximum number of tokens to generate for the formal language query and a hyperparameter specifying a temperature value for generating the formal language query.

16. A non-transitory computer-readable storage medium comprising instruction that, when executed by a processing device, cause the processing device to perform operations comprising:
receiving a request to generate a formal language query to search cybersecurity data associated with a plurality of computing resources of one or more entities, wherein the request specifies a natural language query pertaining to the cybersecurity data associated with the plurality of computing resources;
generating a prompt comprising: (i) at least part of the natural language query from the request to generate the formal language query, (ii) a set of instructions for generating the formal language query, and (iii) one or more examples pertaining to the natural language query;
providing the prompt as input to a trained generative artificial intelligence (AI) model; obtaining one or more outputs of the trained generative AI model, the one or more outputs
indicating a formal language query corresponding to the natural language query; and
causing the formal language query to be executed to search the cybersecurity data associated with the plurality of computing resources.

17. The non-transitory computer-readable storage medium of claim 16, wherein the processing device is to perform operations further comprising:
providing a user interface (UI) comprising one or more UI elements for receiving the request to generate the formal language query, wherein the one or more UI elements is presented in a first area of the UL

18. The non-transitory computer-readable storage medium of claim 17, wherein the processing device is to perform operations further comprising:
causing the formal language query to be presented in a second area of the UL

19. The non-transitory computer-readable storage medium of claim 17, wherein the UI comprises one or more additional UI elements for receiving the request to provide feedback on the formal language query.

20. The non-transitory computer-readable storage medium of claim 16, wherein the prompt further comprises at least one of: a maximum number of tokens to generate for the formal language query and a hyperparameter specifying a temperature value for generating the formal language query.
